(19) United States
(12) Patent Application Publication
(10) Pub. No.: US 2026/0320424 A1
(43) Pub. Date: Oct. 15, 2026

(54) Epistemic Boundary Formation Without Decision

(71) Applicant: Jody Rahsaan Jones, Queens, NY (US)

(72) Inventor: Jody Rahsaan Jones, Queens, NY (US)

(21) Appl. No.: 19/531,968

(22) Filed: Feb. 6, 2026

(51) Int. Cl. G06N 5/022

(52) U.S. Cl. CPC G06N 5/022

(57) ABSTRACT

An epistemic boundary formation architecture is disclosed that asserts existence of communicative selections or signals without interpretation, evaluation, acceptance, or consequence. Upon occurrence of a qualifying epistemic event, an Epistemic Discriminant Envelope records existence as a structural fact in a content-agnostic, minimally sufficient manner, permitting partial structure and explicit UNKNOWN and UNCOMPUTED states.

Boundary formation is mandatory or results in an explicit refusal record, and silent omission is prohibited. Boundary records are immutable and append-only and do not encode meaning, geometry, relational force, obligation, permission, or authority.

Coordinated enforcement of these constraints produces a system-level effect of existence without judgment, enabling audit-safe, autonomy-preserving registration of epistemic events without filtering, validation, or governance.

### 1. TECHNICAL FIELD

### 1.1 Epistemic Boundary and Existence Registration Systems

The present invention relates to computational architectures for epistemic boundary and existence registration within multi-layered information systems. More specifically, it concerns architectures that record the existence of epistemic boundaries, defined as structural points at which communicative selections, signals, or qualifying events occur, without interpreting content, performing measurement, assessing validity, or assigning consequence.

Epistemic boundary and existence registration systems address how events become present to a system as structural facts. Such systems are applicable to environments in which communicative activity, signaling, or selection must be acknowledged as having occurred regardless of semantic coherence, relevance, correctness, or outcome. The present invention operates at the level of existence registration only, and does not compute informational structure, relational force, communicative admissibility, continuity, or evaluation.

By treating boundary formation as a first-class architectural concern, the invention enables systems to record that something exists within the epistemic space without deciding what it means, what it permits, what it implies, or what should follow.

### 1.2 Pre-Interpretive State Formation Architectures

The present invention further pertains to pre-interpretive state formation architectures, in which epistemic states are formed prior to and independent of semantic interpretation, informational measurement, relational constraint, evaluative assessment, policy application, or action.

In such architectures, state formation does not depend on coherence, completeness, correctness, approval, or acceptance. An epistemic boundary is formed when a qualifying structural event occurs, not when downstream systems have interpreted, validated, measured, or resolved it. The invention therefore separates existence from understanding and registration from resolution.

Pre-interpretive state formation prevents retroactive existence, delayed acknowledgment, and inference-based omission. It ensures that epistemic material is registered at the moment of occurrence, even when interpretation, measurement, relational geometry, or evaluation has not yet been computed or may never be computed.

### 1.3 Authority-safe Existence Assertion Layers

The present invention also relates to authority-safe existence assertion layers, defined as architectural layers that assert the existence of epistemic material without asserting legitimacy, correctness, acceptance, endorsement, permission, or consequence.

Within such layers, existence is recorded as a structural fact only. The act of registering an epistemic boundary does not validate content, approve behavior, authorize interaction, assign priority, or imply trust, attention, urgency, or importance. Existence assertion is explicitly decoupled from all normative, evaluative, and attentional semantics.

Formation of an epistemic boundary does not define admissible interaction, relational force, communicative possibility, agent continuity, or carried state across time. It does not perform informational measurement, generate salience, or function as a signal for downstream processing.

By denying authority at the point of existence assertion, the invention prevents boundary formation from becoming a covert filtering, moderation, analytics, or governance mechanism. Existence is acknowledged without judgment or leverage, enabling downstream systems to interpret, evaluate, act upon, or ignore epistemic material only under explicitly assumed authority, rather than by architectural implication.

This authority-safe positioning makes the invention suitable for autonomy-preserving, audit-critical, and governance-sensitive systems in which the fact that something occurred must be recorded without that record itself exerting power, influence, or control.

### 2. BACKGROUND AND FAILURE MODES

### 2.1 Collapse of Existence Into Evaluation or Acceptance

In many systems, the act of registering epistemic material is implicitly treated as evaluation, acceptance, endorsement, or approval. Content is recorded only after it passes validation, moderation, relevance checks, coherence thresholds, or authorization criteria, causing existence to become contingent on judgment.

This collapse eliminates the distinction between something having occurred and something having been accepted. Systems exhibiting this failure cannot represent rejected, ignored, uninterpreted, or unresolved material as existing facts, and existence becomes a reward for approval rather than a neutral acknowledgment of occurrence. The present invention addresses this failure by structurally separating existence registration from all evaluative, acceptance, and approval semantics.

### 2.2 Delayed or Retroactive Boundary Formation

Another common failure arises when epistemic boundaries are formed only after interpretation, aggregation, measurement, or downstream analysis. Systems delay existence registration until meaning has been assigned, geometry computed, or relevance determined, and in some cases reconstruct boundaries retroactively from logs or inferred history.

Delayed or retroactive formation undermines temporal integrity by allowing systems to erase, rewrite, or reframe the past based on present knowledge, and prevents faithful recording of when epistemic material first entered the system. This failure mode also enables selective acknowledgment, in which only “successful,” “useful,” or approved material is later treated as having existed. The present invention rejects delayed and retroactive boundary formation by requiring that existence be asserted at the moment a qualifying structural event occurs, not after interpretation or outcome.

### 2.3 Filtering and Validation at Formation Time

Many architectures perform filtering, validation, eligibility checking, or authorization screening at the point of boundary formation, preventing material from being registered as existing unless it satisfies correctness, coherence, compliance, or policy constraints.

Such filtering conflates boundary formation with gatekeeping and prevents systems from recording the occurrence of invalid, incoherent, unauthorized, or non-compliant material as structural facts, thereby obscuring the difference between what happened and what was allowed. The present invention prohibits filtering and validation at formation time, requiring that boundary formation record occurrence rather than admissibility, with any decision to filter, suppress, or act upon material occurring only downstream under explicit authority.

### 2.4 Silent Omission and Non-Recording Failures

A further failure mode involves silent omission, in which epistemic material that does not meet certain criteria is simply not recorded, without explicit refusal or trace.

Silent omission erases evidence of occurrence and prevents audit, reconstruction, or accountability by collapsing absence of record into absence of event. Systems exhibiting this failure cannot distinguish between nothing happened and something happened but was ignored, enabling covert control through non-recording. The present invention requires that qualifying epistemic events result either in boundary formation or in an explicitly recorded refusal state, and that silence must never erase existence.

### 2.5 Mutation and Completion Drift

In some systems, initial records of epistemic material are later mutated, completed, or refined as additional information becomes available, with partial records updated in place to reflect later interpretation, geometry, or evaluation.

This mutation introduces completion drift, in which the meaning and content of an original boundary changes over time, collapsing pre-interpretive existence into post-interpretive state and destroying the ability to inspect what was known, unknown, or uncomputed at the moment of occurrence. The present invention prohibits mutation of epistemic boundaries, requiring that once formed, boundaries remain immutable, with any additional structure recorded only by creating new boundaries rather than altering existing ones.

### 2.6 Conflation of Boundary With Meaning or Consequence

Finally, many systems conflate the existence of a boundary with meaning, relevance, importance, or consequence, treating the fact that something is registered as evidence that it matters, warrants attention, or requires response.

This conflation transforms existence into influence and makes boundary formation a de facto signal for attention or action, even when no such intent exists. Systems exhibiting this failure cannot represent neutral existence without implicit pressure. The present invention explicitly denies any interpretation of boundary existence as meaning or consequence, specifying that existence answers only that a structural event occurred, while meaning, importance, and action remain strictly outside the scope of boundary formation.

### 3. PURPOSE AND SCOPE OF THE INVENTION

### 3.1 Purpose of Epistemic Boundary Formation

The purpose of the present invention is to establish epistemic boundary formation as a first-class architectural function that records the existence of communicative selections, signals, or qualifying epistemic events without interpretation, validation, approval, or decision.

Epistemic boundary formation answers a single structural question: has a qualifying epistemic event occurred. It does not answer what the event means, whether it is correct, whether it is relevant, whether it is acceptable, or what should follow. By separating existence from interpretation, the invention ensures that epistemic material becomes present to the system as a structural fact at the moment of occurrence, rather than as a consequence of downstream analysis, coherence checking, or approval.

This purpose restores a foundational capability absent in many systems: the ability to acknowledge that something happened without simultaneously judging it. Epistemic boundary formation therefore provides a neutral entry point into the system's epistemic space, upon which later interpretation, measurement, or evaluation may operate without retroactively controlling what is allowed to exist.

### 3.2 Scope of Non-Evaluative, Non-Decisional Existence

The scope of the present invention is limited to non-evaluative, non-decisional existence registration.

Within this scope, boundary formation does not validate or invalidate content, does not accept or reject inputs, does not filter or gate participation, does not assess coherence, relevance, correctness, or importance, and does not authorize consequence, enforcement, or action.

Existence is asserted regardless of content quality, correctness, completeness, or downstream usefulness.

Partial structure is permitted, and absence of computation, analysis, or resolution is preserved explicitly. Unknown, uncomputed, inapplicable, or incomplete states are treated as first-class outcomes, not as errors or deficiencies to be resolved.

The present invention explicitly excludes any mechanism that would allow existence registration to become a proxy for moderation, approval, trust signaling, prioritization, or decision-making. Any such determination must occur downstream under explicitly assumed authority, not at the point of boundary formation.

### 3.3 Relationship to the Non-Collapse Architectural Stack

The epistemic boundary formation architecture disclosed herein operates as an upstream, pre-interpretive layer within a broader non-collapse architectural stack.

Within this stack, boundary formation asserts that an epistemic event exists, informational measurement observes structure without leverage, relational force geometry constrains possibility without governance, communicative routing determines admissible interaction without consent inference, interpretation assigns structure without authority, evaluation observes without deciding, and action occurs only through explicit external authority.

The present invention supplies the existence anchor for all downstream processing by ensuring that epistemic material is registered before and independent of interpretation, measurement, coherence assessment, or evaluation. By doing so, it prevents retroactive existence, selective acknowledgment, and inference-based omission.

This positioning enforces the core non-collapse invariant that no downstream layer may decide what is allowed to exist by virtue of what it means, how it measures, or what it implies.

Existence is recorded once, neutrally, and immutably, and all subsequent reasoning must respect that record.

### 4. TRIGGER CONDITIONS FOR BOUNDARY FORMATION

### 4.1 Communicative Selection or Signal Occurrence

An Epistemic Discriminant Envelope (EDE) must be formed upon the occurrence of a communicative selection or signal. A communicative selection or signal includes any structurally identifiable act by which information is emitted, selected, or presented to the system, regardless of source, form, modality, or intent. Boundary formation is triggered by the occurrence of such an act itself, not by its interpretation, coherence, authorization, acceptance, or consequence.

The present invention treats the occurrence of a communicative selection or signal as a sufficient structural condition for boundary formation. No additional criteria, including correctness, relevance, completeness, approval, or downstream utility, are required. Boundary formation is therefore event-driven rather than outcome-driven, ensuring that epistemic existence is acknowledged at the moment of occurrence rather than as a byproduct of later judgment.

### 4.2 Content-Agnostic Formation

Epistemic boundary formation under the present invention is content-agnostic. The content of a communicative selection or signal, whether semantic, symbolic, numerical, encoded, malformed, partial, or uninterpretable, must not influence whether an Epistemic Discriminant Envelope is formed.

Boundary formation does not depend on what is expressed, how it is expressed, or whether it is interpretable, coherent, correct, or valid under any framework. No parsing, semantic analysis, structural interpretation, or validation is required to trigger existence registration, and the invention explicitly prohibits conditioning boundary formation on content-based properties.

This content-agnostic requirement ensures that existence is recorded independently of meaning and prevents boundary formation from functioning as an implicit filtering, moderation, or validation mechanism.

### 4.3 Independence From Routing, Coherence, or Evaluation

Epistemic boundary formation is independent of routing, coherence assessment, and evaluation. The decision to form an Epistemic Discriminant Envelope must not consult or depend upon whether a signal can be routed to any entity, whether it is coherent under any interpretive framework, whether it is relevant, important, admissible, or actionable, or whether it would produce any downstream effect.

Boundary formation occurs prior to and independently of all routing, measurement, coherence classification, relational constraint evaluation, or policy assessment. The existence of a boundary must not be delayed, denied, suppressed, or retroactively altered based on outcomes of downstream analysis.

By enforcing independence from routing, coherence, and evaluation, the invention ensures that epistemic existence is not contingent on interpretive success, institutional approval, or downstream utility. Existence is asserted once, at occurrence, and remains insulated from all subsequent judgment.

### 5. MINIMAL SUFFICIENCY AND PARTIAL STRUCTURE

### 5.1 Minimal Structural Requirements for Ede Formation

An Epistemic Discriminant Envelope (EDE) is valid upon satisfaction of minimal structural sufficiency. Minimal sufficiency requires only that a qualifying communicative selection or signal has occurred and that the occurrence can be structurally identified as an epistemic event.

No additional structure is required for EDE formation, including interpretation, classification, informational measurement, relational geometry, relevance assessment, coherence checking, or evaluation. Boundary validity does not depend on completeness, correctness, richness, or downstream usability of any kind.

The present invention explicitly rejects any requirement that an epistemic boundary be “ready for use” before it may exist. An EDE may be sparse, incomplete, or minimally populated and remains valid as an existence assertion, ensuring that existence is not conditioned on analytical readiness or processing progress.

### 5.2 Partial Participation Across Epistemic Axes

EDE formation permits partial participation across epistemic axes. An EDE may include participation indicators for multiple epistemic dimensions, including orientation, temporal structure, relational context, or informational measurement, without requiring that all such dimensions be present or computed at formation time.

Each epistemic axis is treated independently, such that presence of one axis does not require presence of any other axis, and absence of an axis does not invalidate the EDE or diminish its status as an existence record.

Absence of axis participation must not be interpreted as negation, failure, suppression, exclusion, or refusal. By allowing partial participation, the invention prevents boundary formation from being delayed until full analysis is available and preserves the ability to represent epistemic material that is only partially structured or partially processed.

### 5.3 Explicit Unknown and Uncomputed States

The present invention requires explicit representation of UNKNOWN and UNCOMPUTED states within each Epistemic Discriminant Envelope.

For every epistemic axis or structural dimension, the EDE must structurally distinguish between values that are known and recorded, values that are unknown at formation time, and values that are uncomputed due to deferred, unavailable, or inapplicable processing.

UNKNOWN and UNCOMPUTED are first-class structural states and must not be collapsed into defaults, nulls, neutral values, or inferred substitutes, and must not be silently repaired, completed, or resolved by later processing.

By requiring explicit representation of unknown and uncomputed structure, the invention preserves epistemic honesty and auditability, ensuring that absence of structure remains visible as absence rather than being misrepresented as certainty, insignificance, or completion.

### 6. EDE COMPOSITION AND RECORDED STRUCTURE

### 6.1 Boundary Identity and Canonical Reference

Each Epistemic Discriminant Envelope (EDE) possesses a stable boundary identity that uniquely distinguishes it as a recorded epistemic event. Boundary identity is assigned at the moment of formation and remains immutable thereafter, serving as the canonical reference by which the boundary may be addressed, inspected, or related to other structural records across the system.

Boundary identity does not encode meaning, priority, authority, legitimacy, or consequence and functions solely as a persistent identifier of existence. The present invention explicitly prohibits reassignment, reuse, mutation, or consolidation of boundary identities.

Any subsequent epistemic event, even if related in content, origin, or structure, must result in a new EDE with its own identity, ensuring that existence is recorded discretely and preventing retroactive conflation, rewriting, or reinterpretation of epistemic boundaries.

### 6.2 Axis Participation Flags

Each EDE records axis participation flags indicating which epistemic axes are present, absent, unknown, or uncomputed at the time of formation.

Axis participation flags do not encode values, interpretations, evaluations, or results, and declare only whether a given axis has participated in the boundary at formation time and, if not, whether its absence reflects unknown structure, deferred computation, or inapplicability.

Axis participation flags are independent across axes, such that participation in one axis does not require participation in any other axis, and absence of participation must not be interpreted as negation, rejection, suppression, or failure.

By recording axis participation explicitly, the invention preserves partial structure without forcing premature completion or inference, enabling downstream systems to reason about what is known and unknown while respecting the immutability of the original boundary.

### 6.3 Provenance and Origin Attribution

Each EDE records provenance and origin attribution sufficient to identify the structural source of the boundary for purposes of traceability, audit, and replay.

Provenance may include identification of the originating entity or system component, the class of communicative selection or signal, the canonical present at which formation occurred, and any structural metadata required for inspection, without limitation.

Provenance records are descriptive rather than interpretive and do not assert intention, consent, responsibility, authorship endorsement, trust, or legitimacy. Provenance must not be treated as evidence of belief, accountability, or normative standing.

By recording provenance explicitly while denying interpretive semantics, the invention ensures that epistemic boundaries are traceable without converting origin information into authority, blame, or meaning.

### 6.4 Explicit Refusal State Representation

The present invention requires explicit representation of refusal states when boundary formation does not proceed to full EDE creation.

A refusal state is a first-class structural record indicating that a qualifying communicative selection or signal was detected and that EDE formation was explicitly withheld under declared system rules, rather than omitted silently.

Refusal states do not imply rejection, invalidation, suppression, error, fault, or non-compliance and carry no evaluative or normative meaning, representing only that boundary formation was explicitly declined.

The architecture prohibits silent non-recording; any qualifying epistemic event must result either in an EDE or in an explicitly recorded refusal state.

By requiring explicit refusal representation, the invention ensures that silence does not erase existence, preserves auditability, and makes any decision not to form a boundary itself structurally visible and inspectable without collapsing refusal into judgment or control.

### 7. PROHIBITION ON EVALUATION AND ACCEPTANCE SEMANTICS

### 7.1 No Validation or Legitimacy Assertion

Epistemic boundary formation under the present invention must not assert validation, legitimacy, correctness, authorization, admissibility, or compliance of any communicative selection or signal.

The act of forming an Epistemic Discriminant Envelope records only that a qualifying epistemic event occurred and does not certify that the event is valid, permitted, trustworthy, policy-compliant, or within any standard. Boundary existence must not be interpreted as approval, authorization, or endorsement of content.

No component involved in EDE formation may consult validation rules, legitimacy criteria, authorization checks, correctness assessments, or compliance policies. All such determinations, where required, must occur downstream under explicitly assumed authority and must not retroactively affect existence registration.

### 7.2 No Acceptance or Endorsement Semantics

Formation of an Epistemic Discriminant Envelope does not constitute acceptance, acknowledgment, endorsement, agreement, or adoption by the system or by any agent.

Boundary formation must not be treated as evidence that content has been received, understood, agreed with, trusted, or acted upon, and does not indicate consent, assent, confidence, or willingness to engage. Existence is recorded independently of any response, reaction, or uptake.

This prohibition applies uniformly regardless of the source of the signal, the identity or authority of the originator, or the apparent intent of the communicative act. By explicitly denying acceptance semantics, the invention prevents boundary formation from being misused as moderation, trust signaling, confirmation, or compliance acknowledgment.

### 7.3 No Filtering or Rejection at Formation

The present invention explicitly prohibits filtering, screening, suppression, or rejection of epistemic material at the point of boundary formation.

EDE formation must not be conditioned on content properties, structural completeness, coherence, relevance, policy compliance, admissibility, or downstream utility. Qualifying epistemic events must result either in boundary formation or in an explicitly recorded refusal state, and silent filtering or non-recording is disallowed.

Any mechanism that prevents existence registration by discarding or suppressing epistemic events at formation time violates the architectural constraints of the present invention.

Decisions to filter, reject, suppress, moderate, or act upon content must be performed only downstream under explicit authority and must not retroactively erase, rewrite, or invalidate the fact that the event occurred.

By denying filtering and rejection at formation, the invention preserves a clean separation between existence and judgment, ensuring that epistemic boundary formation remains a neutral, non-decisional acknowledgment of occurrence.

### 8. IMMUTABILITY AND APPEND-ONLY FORMATION

### 8.1 No Post-Formation Mutation

An Epistemic Discriminant Envelope (EDE) is immutable once formed.

After formation, no component may modify, enrich, correct, complete, reinterpret, or otherwise alter the contents of an EDE, regardless of whether additional information, computation, interpretation, or evaluation becomes available at a later time.

Post-formation mutation is explicitly disallowed because it collapses pre-interpretive existence into post-interpretive state, permitting later knowledge or judgment to rewrite what was originally unknown, uncomputed, or absent.

Allowing such mutation would undermine auditability, enable retroactive control, and erase the distinction between what existed at the moment of occurrence and what was later inferred.

The present invention therefore requires that each EDE remain a fixed representation of what was known, unknown, and uncomputed at the moment of boundary formation.

### 8.2 New Boundaries Via New Envelopes Only

Any subsequent epistemic structure arising after initial boundary formation must be represented through the creation of new Epistemic Discriminant Envelopes, rather than by modification of existing ones.

Later interpretation, informational measurement, relational geometry, coherence assessment, evaluation, or consequence reasoning must produce separate, newly formed envelopes that may reference earlier EDEs where appropriate but must not replace, revise, or overwrite them.

These later envelopes coexist with the original boundary as distinct structural records, preserving the original existence assertion intact.

This append-only rule ensures that epistemic development is represented as a sequence of discrete structural events rather than as mutation of past existence.

By enforcing append-only formation, the invention prevents collapse of “what happened” into “what was later decided” and preserves the integrity of historical epistemic records.

### 8.3 Identity Stability Across Canonical Time

Each Epistemic Discriminant Envelope maintains identity stability across canonical time.

Once an identity is assigned at formation, it must remain constant and uniquely associated with that boundary for the lifetime of the system, and must not be reused, reassigned, merged, split, aliased, or otherwise repurposed across canonical presents.

Identity stability ensures that epistemic boundaries remain traceable, referable, and distinguishable without ambiguity, enabling downstream systems to relate boundaries structurally without risk of identity drift or historical conflation.

By enforcing immutable identity across time, the invention guarantees that existence records remain stable anchors within the non-collapse architectural stack and remain immune to reinterpretation, consolidation, or rewriting driven by later events.

### 9. PROHIBITION ON GEOMETRY, MEANING, OR FORCE ENCODING

### 9.1 Pre-Geometry Boundary Formation

Epistemic boundary formation under the present invention is pre-geometry.

An Epistemic Discriminant Envelope (EDE) must not encode, imply, or depend upon any geometric structure, relational configuration, force topology, spatial arrangement, or conceptual layout. Boundary formation occurs prior to any computation of orientation, realis posture, temporal structure, relational admissibility, informational measurement, coherence classification, or interpretive geometry.

An EDE may reference whether such dimensions are present, unknown, or uncomputed, but must not contain geometric values, vectors, fields, axes, or constraints. Geometry is always downstream of boundary formation and must never condition the fact of existence.

By enforcing pre-geometry boundary formation, the invention ensures that existence is asserted before any notion of structure, preventing later geometric computation from retroactively determining whether something was allowed to exist.

### 9.2 No Semantic or Interpretive Content

The present invention explicitly prohibits semantic or interpretive content within Epistemic Discriminant Envelopes.

EDEs must not contain semantic representations, meaning assignments, topic classifications, intent inferences, stance attributions, relevance labels, interpretive summaries, or any derivative of semantic analysis.

Boundary formation does not parse, analyze, classify, or interpret content and records only that a qualifying communicative selection or signal occurred, not what it signifies. Any attempt to embed semantic interpretation at formation time collapses existence into meaning and violates the architectural constraints of the present invention.

All semantic and interpretive processing must occur in downstream layers that explicitly assume interpretive authority and must not feed back into EDE structure.

### 9.3 No Force, Obligation, or Authority Encoding

Epistemic Discriminant Envelopes must not encode force, obligation, permission, legitimacy, authority, or admissibility.

The existence of an EDE does not imply that any entity may act, must act, is obligated, is permitted, or is authorized. Boundary formation does not grant standing, create duty, impose consequence, license interaction, trigger evaluation, or justify enforcement.

EDEs therefore must not be treated as commands, requests, permissions, approvals, denials, or policy signals, and represent existence without power.

By denying force and authority encoding at the boundary formation layer, the invention prevents existence registration from becoming a covert governance mechanism and preserves a clean separation between the fact that something occurred and any decision about what should be done.

### 10. NON-SKIPPING AND EXPLICIT REFUSAL INVARIANTS

### 10.1 Mandatory Boundary Formation

The architecture mandates boundary formation for every qualifying communicative selection or signal. When a structurally identifiable epistemic event occurs, the system must either form an Epistemic Discriminant Envelope (EDE) or record an explicit refusal state, and must not silently decline to register existence, delay formation pending analysis, or condition formation on downstream criteria.

Mandatory boundary formation ensures that existence is acknowledged at the moment of occurrence and that no component may decide that an epistemic event “does not count” by omission, suppression, or deferral. This invariant prevents covert filtering, retroactive acknowledgment, selective visibility, and inference-based omission of epistemic material.

### 10.2 Explicit Refusal as First-Class State

Where boundary formation does not proceed to full EDE creation under declared system rules, the architecture requires recording an explicit refusal state as a first-class structural record.

An explicit refusal state indicates that a qualifying epistemic event was detected and that boundary formation was affirmatively withheld, and must be recorded with sufficient identity and provenance to preserve auditability and traceability.

Refusal does not imply rejection, invalidation, suppression, error, or fault, and represents only that existence registration was explicitly declined rather than silently omitted. Refusal must not erase, rewrite, or obscure the fact that the epistemic event occurred.

By elevating refusal to a first-class state, the invention ensures that non-formation decisions are visible, inspectable, and distinguishable from non-occurrence.

### 10.3 Silence Preservation Without Erasure

The present invention enforces silence preservation as a core architectural invariant.

Silence, defined as absence of boundary formation, absence of computation, or absence of interpretation, must not erase or obscure existence. Where no EDE is formed, the reason must be explicitly represented as refusal, and where no structure is computed, UNKNOWN or UNCOMPUTED states must be recorded.

Silence must not be collapsed into absence of event, neutrality, insignificance, irrelevance, or safety, and structural absence must be preserved as absence rather than non-existence.

By enforcing silence preservation, the invention ensures epistemic honesty and auditability, prevents control through non-recording, and preserves a faithful record of epistemic events regardless of downstream engagement, interpretation, or judgment.

### 11. ONE-WAY DEPENDENCY AND NON-FEEDBACK INVARIANTS

### 11.1 Pre-Interpretive Positioning

Epistemic boundary formation under the present invention operates pre-interpretively within the architectural stack.

An Epistemic Discriminant Envelope (EDE) is formed prior to semantic interpretation, informational measurement, relational force computation, communicative routing, coherence assessment, evaluation, eligibility resolution, or action. Boundary formation consumes only the occurrence of a qualifying epistemic event and does not consult meaning, content, structure, geometry, or consequence.

By occupying a pre-interpretive position, the invention ensures that existence is asserted independently of how an event is later understood, measured, or judged. Meaning may depend on existence, but existence must not depend on meaning, and this positioning prevents semantic backflow or interpretive influence from retroactively determining whether something was allowed to exist.

### 11.2 Prohibition on Upstream or Downstream Modification

The present invention explicitly prohibits modification of Epistemic Discriminant Envelopes by any upstream or downstream process.

No component, whether responsible for signal preprocessing, interpretation, informational measurement, relational force geometry, routing, coherence classification, evaluation, policy application, governance, or execution, may modify, refine, normalize, complete, reinterpret, or otherwise alter an existing EDE after formation.

Upstream processing must not alter boundary identity or recorded structural states after formation, and downstream analysis must not write computed structure, judgments, or conclusions back into an EDE. No process may “correct,” “complete,” repair,” or enrich an EDE based on later knowledge.

Any additional epistemic structure must be recorded only through formation of a new Epistemic Discriminant Envelope, preserving the original boundary intact. This prohibition enforces immutability and prevents existence from being reshaped by interpretation, measurement, or outcome.

### 11.3 Determinism and Auditability

Epistemic boundary formation under the present invention is deterministic and auditable.

Given identical qualifying epistemic events and identical formation rules, the system must produce identical Epistemic Discriminant Envelopes or identical refusal records, and no stochastic behavior, heuristic inference, learning, normalization, or adaptive variation is permitted at the formation layer.

Each EDE must be fully auditable, with boundary identity, provenance, axis participation flags, and UNKNOWN or UNCOMPUTED states inspectable and traceable to the moment of formation. Auditability arises from explicit recorded fact, not from reconstruction, inference, or interpretation.

By enforcing determinism and auditability, the invention ensures that existence registration remains stable, replayable, and resistant to reinterpretation, such that the epistemic record reflects what occurred and what was known at the time-no more and no less.

### 12. ARCHITECTURAL EFFECT AND CLAIM BASIS

### 12.1 Inseparability of Boundary Formation Constraints

The epistemic boundary formation architecture disclosed herein derives its lawful behavior from the inseparable enforcement of its boundary formation constraints. No individual constraint, including event-driven formation, content agnosticism, minimal structural sufficiency, explicit representation of UNKNOWN and UNCOMPUTED states, immutability, append-only formation, or non-skipping guarantees, produces the claimed architectural effect in isolation.

If boundary formation is permitted only after evaluation, existence collapses into acceptance; if partial structure is disallowed, existence becomes contingent on completeness; if UNKNOWN or UNCOMPUTED states are collapsed or repaired, absence is misrepresented as certainty; if mutation is allowed, later judgment rewrites earlier existence; and if refusal is not explicit, silence becomes erasure.

The architectural effect arises only when all constraints operate together, such that existence is asserted at the moment of occurrence, independently of meaning or outcome, partial structure is valid, absence is explicit, and records are immutable and append-only. Removal, weakening, or reordering of any constraint reintroduces the failure modes the invention prevents, including retroactive existence, covert filtering, and judgment at formation time.

Accordingly, the present invention claims the coordinated operation of boundary formation constraints as a unified architectural whole, rather than any individual data structure, mechanism, or formation routine viewed in isolation.

### 12.2 Prohibition on Partial or Selective Implementation

The present invention explicitly prohibits partial or selective implementation of the epistemic boundary formation architecture.

Selective implementation includes configurations that form boundaries only after validation, moderation, or coherence checks; permit existence registration only when full structure is available; record existence while collapsing UNKNOWN or UNCOMPUTED states; mutate or complete boundaries based on later analysis; or omit explicit refusal records in favor of silent non-recording.

Such implementations reproduce the appearance of neutral existence while restoring judgment through alternate pathways. The invention therefore defines its scope at the level of architectural effect, not at the level of individual data structures, formation routines, or sequencing choices.

Any system that achieves substantially the same effect, namely asserting epistemic existence without evaluation, acceptance, endorsement, or consequence, falls within the scope of the present claims regardless of differences in terminology, modularization, ordering, or implementation strategy.

### 12.3 Existence Without Judgment as System-level Effect

The system-level contribution of the present invention is existence without judgment.

Existence without judgment is defined as the ability to record that an epistemic event occurred, at the moment of occurrence, without deciding what it means, whether it is valid, whether it matters, or what should follow, such that existence is acknowledged solely as a structural fact.

By enforcing content-agnostic and non-evaluative formation, explicit representation of partiality and absence, immutability, append-only recording, and mandatory formation or explicit refusal, the architecture ensures that boundary formation does not become moderation, filtering, prioritization, or governance by omission.

This effect, namely acknowledgment without acceptance, presence without endorsement, and existence without consequence, distinguishes the present invention from systems that conflate registration with judgment and provides a neutral epistemic substrate upon which interpretation, measurement, evaluation, and action may proceed only under explicitly assumed authority, without retroactively controlling what is allowed to exist.

### 13. Closing Statement

The present invention establishes an epistemic boundary formation architecture that asserts existence without judgment.

By recording the occurrence of communicative selections or signals as epistemic boundaries, the architecture ensures that epistemic material becomes present to the system at the moment of occurrence, independent of interpretation, validation, relevance, correctness, or consequence. Boundary formation is content-agnostic, minimally sufficient, and explicitly tolerant of partial structure, unknown states, and deferred computation.

Crucially, the architecture denies all evaluative, acceptance, and governance semantics at the point of existence registration. Formation of an Epistemic Discriminant Envelope does not constitute acceptance, acknowledgment, validation, endorsement, or permission, and does not encode meaning, geometry, relational force, obligation, or authority. Where formation does not proceed, refusal is explicitly recorded rather than silently omitted, preserving auditability and preventing erasure through silence.

The invention further enforces immutability and append-only behavior. Once formed, epistemic boundaries cannot be modified, completed, corrected, or reinterpreted by later analysis or outcome, and subsequent epistemic structure arises only through formation of new envelopes, preserving a faithful record of what existed, what was unknown, and what was uncomputed at each canonical present.

The architectural effect protected by the present invention arises from the inseparable enforcement of these constraints. Partial or selective implementation reintroduces judgment, filtering, or retroactive control through alternate pathways. Accordingly, the protected subject matter is not a particular data structure, identifier, or formation routine, but the system-level behavior produced by neutral, pre-interpretive existence registration.

By enabling acknowledgment without acceptance and presence without consequence, the invention provides a foundational epistemic substrate suitable for audit-critical, autonomy-preserving, and governance-sensitive systems in which what occurred must be recorded faithfully without that record itself becoming a source of power or control.

### 15. BRIEF SUMMARY

The present invention provides an epistemic boundary formation architecture that records the existence of epistemic events without judgment.

Upon occurrence of a communicative selection or signal, the architecture forms an Epistemic Discriminant Envelope (EDE) that asserts existence as a structural fact independent of content, interpretation, coherence, relevance, evaluation, or consequence. Boundary formation is content-agnostic, minimally sufficient, and tolerant of partial structure, and UNKNOWN and UNCOMPUTED states are explicitly represented as first-class outcomes rather than collapsed into defaults.

The architecture explicitly denies evaluative, acceptance, validation, endorsement, permission, and authority semantics at formation time. Boundary existence does not imply meaning, relevance, legitimacy, priority, or action. Where formation does not proceed, an explicit refusal state is recorded, and silent omission is prohibited, preserving auditability and preventing erasure through non-recording.

Epistemic Discriminant Envelopes are immutable and append-only. Once formed, boundaries cannot be modified, completed, corrected, or reinterpreted by later analysis or outcome, and subsequent epistemic structure is recorded only through formation of new envelopes. This preserves a faithful record of what existed, what was unknown, and what was uncomputed at each canonical present.

By enforcing these constraints inseparably, the invention produces a system-level effect of existence without judgment, defined as acknowledgment without acceptance, presence without endorsement, and recording without consequence. The architecture provides a neutral, pre-interpretive substrate suitable for audit-critical, autonomy-preserving, and governance-sensitive systems in which what occurred must be recorded faithfully without that record itself exerting power.

1. A computer-implemented epistemic boundary formation architecture comprising a formation mechanism that creates an epistemic boundary record upon occurrence of a communicative selection or signal and a boundary record that asserts existence of the epistemic event as a structural fact, wherein boundary formation is content-agnostic, non-evaluative, non-decisional, and independent of interpretation, routing, coherence assessment, evaluation, eligibility resolution, or consequence.

2. The architecture of claim 1, wherein formation of the epistemic boundary record does not constitute acceptance, acknowledgment, validation, endorsement, permission, authorization, or approval of the communicative selection or signal.

3. The architecture of claim 1, wherein boundary formation is triggered solely by occurrence of a communicative selection or signal regardless of content, correctness, relevance, admissibility, or outcome.

4. The architecture of claim 1, wherein boundary formation is performed prior to and independently of semantic interpretation, informational measurement, relational force computation, coherence assessment, evaluation, or action.

5. The architecture of claim 1, wherein boundary formation requires only minimal structural sufficiency and does not require completeness, correctness, or availability of downstream structure.

6. The architecture of claim 1, wherein the boundary record permits partial participation across multiple epistemic axes without requiring participation in all axes at formation time.

7. The architecture of claim 1, wherein unknown and uncomputed states are explicitly represented as first-class structural states within the boundary record.

8. The architecture of claim 1, wherein each boundary record includes a stable boundary identity that is immutable after formation.

9. The architecture of claim 1, wherein each boundary record includes provenance information identifying origin and formation context without asserting intent, legitimacy, endorsement, or responsibility.

10. The architecture of claim 1, wherein, if boundary formation does not proceed to full boundary record creation, an explicit refusal state is recorded.

11. The architecture of claim 10, wherein silent omission of boundary formation without explicit refusal is structurally prohibited.

12. The architecture of claim 1, wherein boundary records are immutable and may not be modified, completed, corrected, or reinterpreted after formation.

13. The architecture of claim 1, wherein subsequent epistemic structure is recorded only through formation of new boundary records rather than mutation of existing records.

14. The architecture of claim 1, wherein boundary identity remains stable across canonical time and is not reused, reassigned, merged, or aliased.

15. The architecture of claim 1, wherein boundary records do not encode semantic meaning, interpretive content, relevance, or importance.

16. The architecture of claim 1, wherein boundary records do not encode geometric structure, relational force, obligation, permission, legitimacy, or authority.

17. The architecture of claim 1, wherein no downstream interpretive, analytical, evaluative, policy, or execution process may modify, normalize, or feed back into boundary records.

18. The architecture of claim 1, wherein formation of boundary records is deterministic and auditable such that identical qualifying events and formation rules produce identical boundary records or identical refusal records.

19. The architecture of claim 1, wherein coordinated enforcement of content-agnostic formation, minimal sufficiency, explicit absence representation, immutability, and non-skipping produces a system-level effect of existence without judgment.

20. The architecture of claim 19, wherein partial or selective implementation of boundary formation constraints is structurally prohibited because removal or weakening of any constraint reintroduces evaluation, filtering, retroactive existence, or control.

21. A method for epistemic boundary formation in a computational system comprising detecting occurrence of a communicative selection or signal, forming an epistemic boundary record asserting existence of the occurrence without interpretation or evaluation, and explicitly recording unknown, uncomputed, or refusal states without omission.

22. A non-transitory computer-readable medium storing instructions that, when executed by one or more processors, cause the processors to implement the epistemic boundary formation architecture of any of claims 1 through 20.
